(19) United States
(12) Patent Application Publication
(10) Pub. No.: US 2011/0248910 A1
(43) Pub. Date: Oct. 13, 2011

(54) METHOD FOR COMPARING TWO CONTINUOUS COMPUTER GENERATED LINES GENERATED BY THE MOVEMENTS OF A COMPUTER MOUSE OR A DIGITIZER TABLET

(75) Inventor: Thien Van PHAM, Poulsbo, WA (US)

(73) Assignee: THIEN VAN PHAM, POULSBO, WA (US)

(21) Appl. No.: 12/758,974

(22) Filed: Apr. 13, 2010

(51) Int. Cl. G09G 5/00

(52) U.S. Cl. 345/156

(57) ABSTRACT

A method is provided for comparing two continuous computer generated lines by using a combination of time, area, velocity and angular velocity and to use a weighted distribution of 10 for time, 40 for area, 40 for velocity and 10 for angular velocity. The method returns true if the sum of the product of the weighted distribution with the percentage difference for time, area, velocity, and angular velocity is greater than or equal to 80, otherwise, the method returns false.

### CROSS-REFERENCE TO RELATED APPLICATIONS

Not Applicable.

### STATEMENT REGARDING FEDERALLY SPONSORED RESEARCH AND DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The present invention relates generally to comparing two continuous computer generated lines generated by the movements of a computer mouse or a digitizer tablet.

The process of comparing two continuous lines for equality is well-established. There are various algorithms that compare two continuous lines for equality, but the majority of algorithms require special digitizer tablets for sensing pressure. Algorithms that do not require pressure as a parameter for determining similarities do not offer the accuracy that is needed to determine if two continuous computer generated lines are similar. Today, there are many companies who have developed their own automated computer based verification system, but these systems make mistakes in recognizing the differences between two continuous lines.

What is needed is a highly reliable method for differentiating two continuous computer generated lines using a weighted distribution from 0 to 100.

### BRIEF SUMMARY OF THE INVENTION

According to the invention, a method is provided for comparing two sets of parametric representation of continuous lines over time. A parametric representation of a continuous line is represented by a set of {(x, y, t)} parameters. (x, y, t) represents a point (x, y) on the continuous line at time t.

In a typical application, the verification process would be performed by first normalizing the set of {(x, y, t)} parameters, calculate the time at each point, calculate the velocity at each point, calculate the angular velocity at each point and calculate the area of the line using the minimum and maximum (x, y) points.

### BRIEF DESCRIPTION OF THE SEVERAL VIEWS OF THE DRAWING

FIG. 1 illustrates a specific embodiment of the invention.

FIG. 2 illustrates a second embodiment of the invention.

### DETAILED DESCRIPTIONS OF THE INVENTION

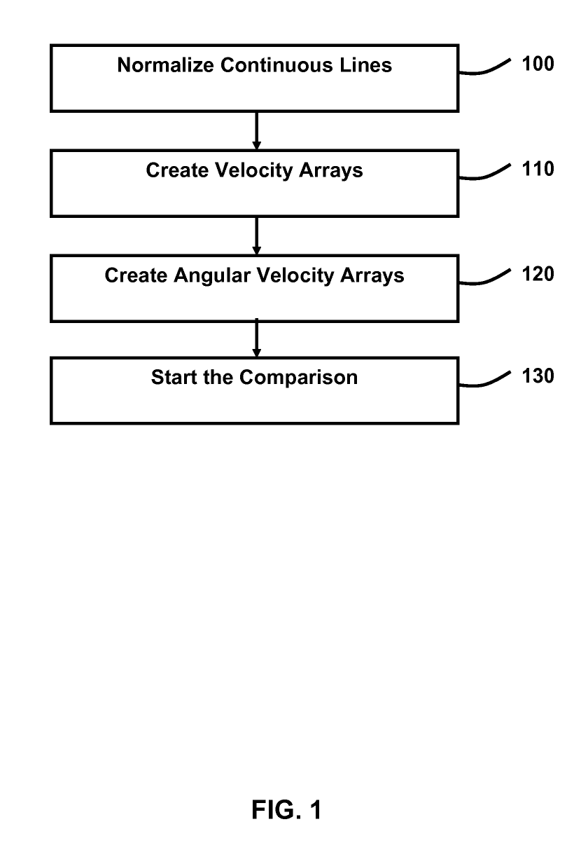

FIG. 1 illustrates the specific embodiment of the present invention, which is a computer software program. Before the present invention is explain in detail, a continuous line generated by the movement of a computer mouse or a digitizer tablet must first be define. A continuous line is defined by a parametric set of values {(x, y, t)}. x and y represents the location of the point on a plane. t represents the time the point was created. The present invention is a computer program function that takes in two continuous lines as parameters and returns a true if the two continuous lines are the same and false if the two lines are not the same. To represent the parameters of the function, the present invention defines them as Line1 and Line2. In step 100, the present invention normalizes Line1 and Line2 by first determining which line has the lowest number of points. Once the present invention determines the line with the lowest number of points, the present invention creates two new arrays representing equal number of points, with the array size label as MinArrayLength. To represent the new arrays, the present invention labels them as LineArray1 and LineArray2. Each array element in LineArray1 and LineArray2 is represented as (x, y, t), which can be define as LineArray1[n]=(x, y, t), for n represents the array index and n is greater than and equal to 0 and n is less than MinArrayLength (0<=n<MinArrayLength). Once the new arrays are created, the present invention copies the (x, y, t) of Line1 to LineArray1 and the (x, y, t) of Line2 to LineArray2. The present invention then continues to step 110.

At step 110, the present invention uses LineArray1 and LineArray2 to create two new velocity arrays, VelocityArray1 and VelocityArray2, respectively. A velocity array is a set of numeric values. The length of the velocity arrays is represented as VAL1 and VAL2; with VAL1 representing the length of VelocityArray1 and VAL2 represents the length of VelocityArray2. VAL1 and VAL2 is 1 less than the MinArrayLength. To calculate the individual velocity array element, the present invention uses two consecutive elements of the newly created line array, LineArray1 and LineArray2. In general, a computer program function can be use to describe the process which is apply to each data element of every element in LineArray1 and LineArray2. In the most general form, this function can be expressed using pseudo code:

For i = 0 to MinArrayLength − 1

VelocityArray1[i] = SQRT((LineArray1[i+1].x −
LineArray1[i].x)\hat{ }2 +

(LineArray1[i+1].y − LineArray1[i].y)\hat{ }2) /
(LineArray1[i+1].t − LineArray1[0].t)

VelocityArray2[i] = SQRT((LineArray2[i+1].x −
LineArray2[i].x)\hat{ }2 +

(LineArray2[i+1].y − LineArray2[i].y)\hat{ }2) /
(LineArray2[i+1].t − LineArray2[0].t)

End For

SQRT is the standard mathematical square root function. The present invention then continues to step 120.

At step 120, the present invention uses LineArray1 and LineArray2 to create two new angular velocity arrays, AVA1 and AVA2, respectively. An angular velocity array is a set of numeric values. The length of the angular velocity array is represented as AVAL1 and AVAL2; with AVAL1 representing the length of AVA1 and AVAL2 represents the length of AVA2. AVAL1 and AVAL2 is 1 less than the MinArrayLength. To calculate the individual angular velocity array element, the present invention uses the first element of the line array and each element of the line array after the first element of the line array. In general, a computer program function can be use to describe the process which is apply to each data element of every element in LineArray1 and LineArray2. In the most general form, this function can be expressed using pseudo code:

For i = 1 to MinArrayLength − 1

AVA1[i−1] = GetAngle(LineArray1[0].x, LineArray1[i].x,
LineArray1[0].y,

LineArray1[i].y) / (LineArray1[i].t − LineArray1[0].t)

AVA2[i−1] = GetAngle(LineArray2[0].x, LineArray2[i].x,
LineArray2[0].y,

LineArray2[i].y) / (LineArray2[i].t − LineArray2[0].t)

End For

GetAngle is a computer program function that takes in 4 parameters, x0, y0, x1, y1 and returns the angle of the line relative to the x, y plane. In general, the GetAngle computer program function can be expressed using pseudo code:

Function GetAngle(x0, y0, x1, y1) As Number

opp is define as a numeric value
adj is define as a numeric value
ang1 is define as a numeric value
opp = y1 − y0
adj = x1 − x0
If x0 = x1 and y0 = y1 Then

Return −1

End If
If adj = 0 Then

If opp >= 0 Then

Return 0

Else

Return 180

End If

Else

ang1 = (Math.Atan(opp / adj)) * 180 / Math.PI
If x0 >= x1 Then

ang1 = 90 − ang1

Else

ang1 = 270 − ang1

End If

End If
Return ang1

End Function

Math.Atan is the standard mathematical arc tangent function. Math.PI is a mathematical standard constant for pi. After the present invention creates the angular velocity arrays, the present invention continues to step 130, where the present invention begins to compare LineArray1 and LineArray2 for similarities.

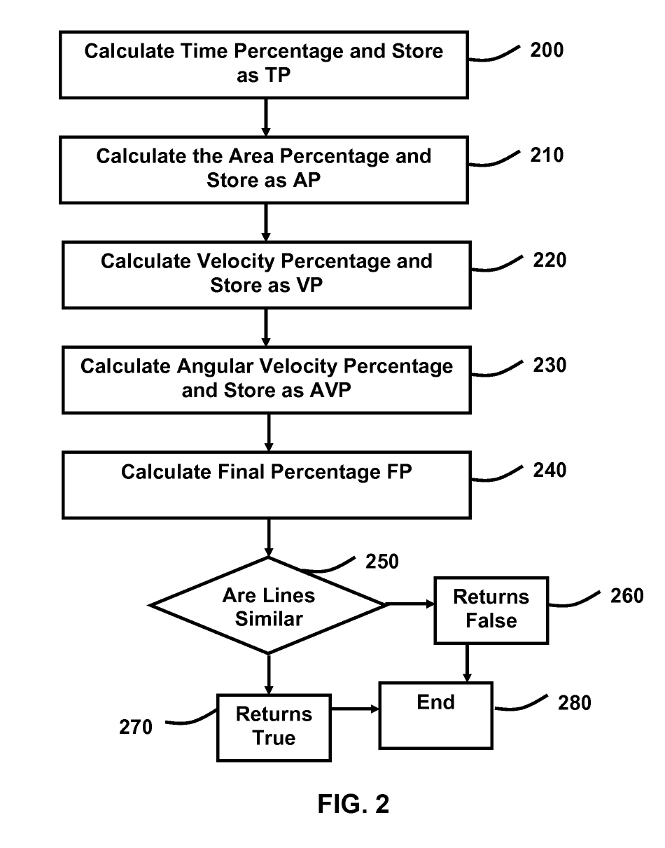

FIG. 2 illustrates the specific embodiment of the present invention, which is a computer software program. At step 200, the present invention uses LineArray1 and LineArray2 to calculate the time percentage and stores it as TP. To calculate the time percentage between LineArray1 and LineArray2, the present invention uses the percentage time difference between two consecutive points. In the most general form, pseudo code can be use to express the calculation of TP.

averagePercentage is a numeric value
weightedPercentage is a numeric value
time1 is a numeric value
time2 is a numeric value
averagePercentage = 0
weightedPercentage = 1 / MinArrayLength
For i = 0 To MinArrayLength − 1

time1 = LineArray1[i+1].t − LineArray1[i].t
time2 = LineArray2[i+1].t − LineArray2[i].t
If time1 < time2 Then

averagePercentage += weightedAverage * (time1/time2)

Else

averagePercentage += weightedAverage * (time2/time1)

End If

End For
TP = averagePercentage

After the present invention calculates the TP, the present invention continues to step 210.

At step 210, the present invention calculates the area percentage difference of LineArray1 and LineArray2. To calculate the area of LineArray1 and LineArray2, the present invention looks for the minimum and maximum x and y values. Once the minimum and maximum x and y values are obtained, the area is calculated by taking the difference between maximum and minimum x and multiply that with the difference between the maximum and minimum y and saves the area as area1 for LineArray1 and area2 for LineArray2. In the most general form, pseudo code can be use to express the calculation of area percentage AP.

difference1X is a numeric value
difference1Y is a numeric value
difference2X is a numeric value
difference2Y is a numeric value
difference1X = GetDifferenceX(LineArray1)
difference1Y = GetDifferenceY(LineArray1)
difference2X = GetDifferenceX(LineArray2)
difference2Y = GetDifferenceY(LineArray2)
area1 = difference1X * difference1Y
area2 = difference2X * difference2Y
If area1 < area2 Then

AP = area1 / area2

Else

AP = area2 / area1

End If

The GetDifferenceX function takes in a set parametric value set {(x, y, t)}, finds the maximum and minimum x values and returns the difference between the maximum and minimum x values. The GetDifferenceY function takes in a set parametric value set {(x, y, t)}, finds the maximum and minimum y values and returns the difference between the maximum and minimum y values. Once the AP is calculated, the present invention continues to step 220.

At step 220, the present invention calculates the difference in velocity percentage between LineArray1 and LineArray2 and stores it as VP. To calculate the difference in velocity percentage between LineArray1 and LineArray2, the present invention uses the VelocityArray1 and VelocityArray2 created in step 110. In the most general form, pseudo code can be use to express the calculation of VP.

averagePercentage is a numeric value
weightedPercentage is a numeric value
averagePercentage = 0
weightedPercentage = 1 / VAL1
For i = 0 To VAL1 − 1

If VelocityArray1[i] < VelocityArray2[i] Then

averagePercentage += weightedAverage * VA1[i] / VA2[i]

Else

averagePercentage += weightedAverage * VA2[i] / VA1[i]

End If

End For
VP = averagePercentage

Once the present invention calculates the difference in velocity percentage VP, the present invention continues to step 230.

At step 230, the present invention calculates the difference in angular velocity percentage between LineArray1 and LineArray2 and stores it as AVP. To calculate the difference in angular velocity percentage between LineArray1 and LineArray2, the present invention uses the AVA1 and AVA2 of step 120. In the most general form, pseudo code can be use to express the calculation of AVP.

averagePercentage is a numeric value
weightedPercentage is a numeric value
averagePercentage = 0
weightedPercentage = 1 / AVAL1
For i = 0 To AVAL1 − 1

If AVA1[i] < AVA2[i] Then

averagePercentage += weightedAverage * AVA1[i] / AVA2[i]

Else

averagePercentage += weightedAverage * AVA2[i] / AVA1[i]

End If

End For
AVP = averagePercentage

Once the present invention calculates the difference in angular velocity percentage AVP, the present invention continues to step 240.

At step 240, the present invention calculates the weighted average distribution by assigning a point value system from 0 to 100. The time percentage has a weighted value of 10. The velocity percentage has a weighted value of 40. The area percentage has a weighted value of 40. The angular velocity percentage has a weighted value of 10. To calculate the final percentage FP, the present invention multiples appropriate average percentage with the corresponding weighted percentage. In most general form, pseudo code can be use to express the final percentage similarity between LineArray1 and LineArray2.

FP=(TP*10)+(AP*40)+(VP*40)+(AVP*10)

After the final percentage FP is calculated, the present invention continues to Step 250.

At step 250, the present invention determines if the final percentage meets a certain criteria. If FP is greater than and equal to 80, then the present continues to step 270. At step 270, the present invention returns a true and continues to step 280 where the present invention ends. If FP is less than 80, then the present invention continues to step 260. At step 260, the present invention returns a false and continues to step 280 where the present invention ends.

This invention has now been explained with reference to specific embodiments. Other embodiments will be apparent to those of ordinary skill in the art in light of this disclosure. It is therefore not intended that this invention be limited except as indicated by the appended claims.

What is claimed is:

1. A method for comparing two continuous computer generated lines by using a combination of the percentage difference in time, the percentage difference in area, the percentage difference in velocity and the percentage difference in angular velocity.

2. A method for comparing two continuous computer generated lines by assigning a weighted distribution value of 10 for the percentage difference in time, 40 for the percentage difference in area, 40 for the percentage difference in velocity and 10 for the percentage difference in angular velocity.

3. A method for comparing two continuous computer generated lines as in claim 2, wherein the method sums the product of the weighted distribution with the percentage difference for time, area, velocity and angular velocity.

4. A method for comparing two continuous computer generated lines as in claim 3, wherein the method returns true if the sums of the product of the weighted distribution with the percentage difference for time, area, velocity, and angular velocity is greater than or equal to 80.

5. A method for comparing two continuous computer generated lines as in claim 3, wherein the method returns false if the sums of the product of the weighted distribution with the percentage difference for time, area, velocity, and angular velocity is less than 80.
